(19) United States
(12) Patent Application Publication
(10) Pub. No.: US 2013/0091022 A1
(43) Pub. Date: Apr. 11, 2013

(54) SYSTEMS AND METHODS FOR BROKERING PREFERENCE SHIELDS

(71) Applicant: David Barrow, Devon (GB)

(72) Inventor: David Barrow, Devon (GB)

(21) Appl. No.: 13/649,033

(22) Filed: Oct. 10, 2012

Related U.S. Application Data
(60) Provisional application No. 61/546,003, filed on Oct. 11, 2011.

(51) Int. Cl. G06Q 20/40; G06Q 30/02

(52) U.S. Cl. 705/14.69; 705/44

(57) ABSTRACT

Systems, methods, and media for brokering preference shields are described herein. An exemplary method may include executing instructions by a processor to receive a request to obtain a preference shield zone from a computing system, the preference shield zone being created by an author, select a preference shield zone from a database of preference shield zones that corresponds to the request, incorporate the preference shield zone into a main preference shield of the consumer, and authorize payment to an author of the preference shield zone.

### CROSS-REFERENCE TO RELATED APPLICATIONS

This non-provisional patent application claims the benefit of provisional U.S. Patent Application Ser. No. 61/546,003, filed on Oct. 11, 2011, entitled “SYSTEMS AND METHODS FOR BROKERING PREFERENCE SHIELDS,” which is hereby incorporated by reference. This non-provisional patent application also relates to provisional U.S. Patent Application Ser. No. 61/546,008, filed on Oct. 11, 2011, entitled “SYSTEMS AND METHODS THAT UTILIZE PREFERENCE SHIELDS AS DATA FILTERS,” provisional U.S. Patent Application Ser. No. 61/673,158, filed on Jul. 18, 2012, entitled “VECTOR-BASED PREFERENCE MATCHING WITH ONTOLOGICAL DATA,” nonprovisional U.S. patent application Ser. No. 12/962,471, filed on Dec. 7, 2010, entitled “SYSTEMS AND METHODS THAT UTILIZE PREFERENCE SHIELDS AS DATA FILTERS,” and to provisional U.S. Patent Application Ser. No. 61/267,767, filed on Dec. 8, 2009, entitled “SEARCH ENGINE USING PREFERENCE SHIELDS AS DATA FILTERS,” which are hereby incorporated by reference in their entirety.

### FIELD OF THE TECHNOLOGY

The present invention relates generally to systems and methods that utilize preference shields as data filters, and more specifically, but not by way of limitation, to systems and methods for brokering preference shields using an exchange.

### SUMMARY OF THE TECHNOLOGY

According to some embodiments, the present technology may be directed to a method that includes the steps of: (a) executing instructions by a processor, the instructions stored in memory, to: (i) receive a request to obtain a preference shield zone from a computing system, the preference shield zone being created by an author; (ii) select a preference shield zone from a database of preference shield zones that corresponds to the request; (iii) incorporate the preference shield zone into a main preference shield of the consumer; and (iv) authorize payment to an author of the preference shield zone.

According to some embodiments, the present technology may be directed to a system that includes: (a) a processor; and (b) logic encoded in one or more tangible media for execution by the processor and when executed operable to perform operations comprising: (i) receiving a request to obtain a preference shield zone from a computing system, the preference shield zone being created by an author; (ii) selecting a preference shield zone from a database of preference shield zones that corresponds to the request; (iii) incorporating the preference shield zone into a main preference shield of the consumer; and (iv) authorizing payment to an author of the preference shield zone.

According to some embodiments, the present technology may be directed to a method for brokering preference shield zones, comprising: (a) executing instructions by a processor, the instructions stored in memory, to: (i) compare a main preference shield of a first user to a plurality of preference shield zones, the main preference shield including preferences corresponding to the interests of the first user, the preference shield zones being included in a database; (ii) select one or more preference shield zones that correspond to the preferences of the first user; (iii) provide the one or more selected preference shield zones to a computing system; (iv) receive a selection of at least one of the one or more selected preference shield zones from the computing system; (v) incorporate the at least one preference shield zone into the main preference shield of the first user; and (vi) authorize payment to an author of the at least one preference shield zone.

According to some embodiments, the present technology may be directed to a non-transitory machine-readable storage medium having embodied thereon a program. In some embodiments the program may be executed by a machine to perform a method. The method may comprise: (a) executing instructions by a processor, the instructions stored in memory, to: (i) receive a request to obtain a preference shield zone from a computing system, the preference shield zone being created by an author; (ii) select a preference shield zone from a database of preference shield zones that corresponds to the request; (iii) incorporate the preference shield zone into a main preference shield of the consumer; and (iv) authorize payment to an author of the preference shield zone.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture in accordance with various embodiments of the present technology.

FIG. 2 is a block diagram of an exemplary preference shield brokering application in accordance with various embodiments of the present technology.

FIG. 3 is a flowchart of an exemplary method for brokering the exchange of preference shield zones.

FIG. 4 is another flowchart of an exemplary method for brokering the exchange of preference shield zones.

FIG. 5 is a block diagram of an exemplary computing system for implementing embodiments of the present technology.

### DETAILED DESCRIPTION OF EXEMPLARY EMBODIMENTS

The rise of general-purpose search engines and applications utilizing search features have obscured the fact that unstructured, free-text searches for Internet content have numerous drawbacks relative to the level of specificity with which search results may be obtained. For example, users interested in museums in Paris, France having Rembrandt paintings may utilize a general-purpose search engine or other application to search for Internet content corresponding to a phrase such as “Rembrandt museum Paris.” A search query such as this may often return excessive volumes of links to websites associated with museums and the like, yet highly relevant results such as the Louvre (having a large collection of Rembrandt paintings) may be buried deeply within the search results, or may be completely omitted. These negative effects may be due, in part, to the relative ease with which search engine optimization techniques may be utilized by companies to artificially elevate irrelevant results within search results for their own benefit.

In contrast, the systems and methods disclosed herein may utilize preference shields as data filters to substantially ameliorate the aforementioned drawbacks and obtain and provide users with relevant and personalized search results. In some embodiments, the systems and methods may allow users to create preference shields that include information indicative of the preferences of the users. The preference shields may be applied to search queries received from a user to provide the user with search results that are personalized relative to the preferences of the user. According to additional embodiments, some of the systems and methods may allow providers (e.g., merchants) to align their inventory and/or advertisements in accordance with the information included in the preference shields of customers.

Exemplary embodiments of the present invention include systems that may store user preferences in preference shields according to well-defined hierarchical structures, which may also be referred to herein as taxonomies. User preferences may be arranged as nodes in such taxonomies and may be entered into the system either directly through an application programming interface (A.P.I.), or through a space-time capsule, which is a specific set of software to connect to the systems of the present invention.

Additionally, the present technology may allow for the brokerage of preference shield zones or entire preference shields between authors and consumers, utilizing a web-based or application accessible preference shield store.

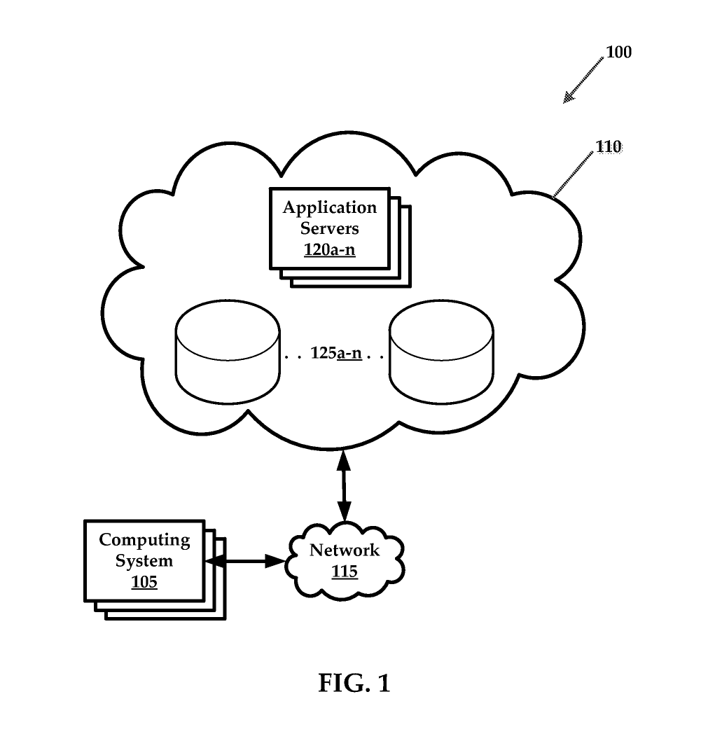

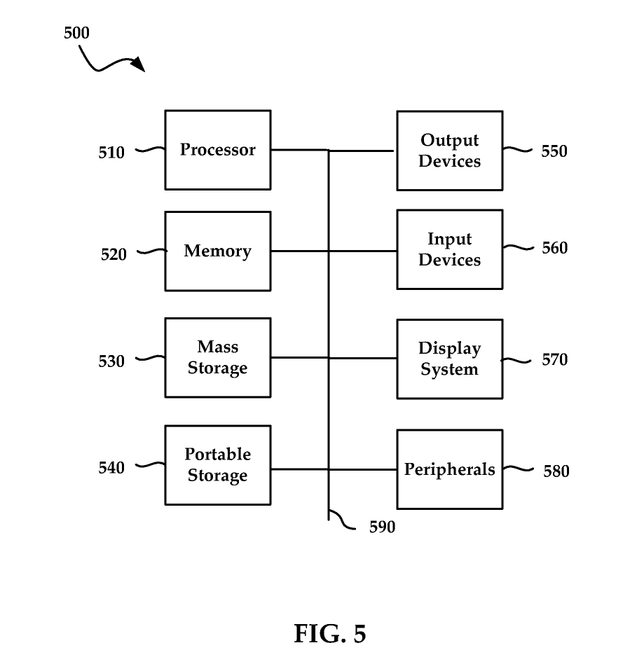

FIG. 1 is a block diagram of an exemplary architecture 100, constructed in accordance with various embodiments of the present technology. The architecture 100 may include a plurality of computing systems 105 such as end user computing systems. It will be understood that the computing systems 105 may include computing systems such as the exemplary computing system 500 described in greater detail with regards to FIG. 5. The computing systems 105 may be interface with a preference shield brokering system, hereinafter “system 110” via a network 115 that may include the Internet, an Intranet network such as a L.A.N. (Local Area Network) or W.A.N. (Wide Area Network), a V.P.N. (Virtual Private Network)—just to name a few.

In some embodiments, the system 110 may be configured as a cloud computing environment. In general, a cloud-based computing environment is a resource that typically combines the computational power of a large grouping of processors (such as within servers 120a-n) and/or that combines the storage capacity of a large grouping of computer memories or storage devices (such as preference shield databases 125a-n). For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers such as application servers 120a-n, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Each of the application servers 120a-n may be described as a computing system adapted for the particular purposes of brokering the exchange of preference shields between authors and consumers. It will be understood that greater detail relative to the creation and maintenance of preference shields are included in nonprovisional U.S. patent application Ser. No. 12/962,471, filed on Dec. 7, 2010, entitled “SYSTEMS AND METHODS THAT UTILIZE PREFERENCE SHIELDS AS DATA FILTERS,” and to provisional U.S. Patent Application Ser. No. 61/267,767, filed on Dec. 8, 2009, entitled “SEARCH ENGINE USING PREFERENCE SHIELDS AS DATA FILTERS,” which are hereby incorporated by reference in their entirety.

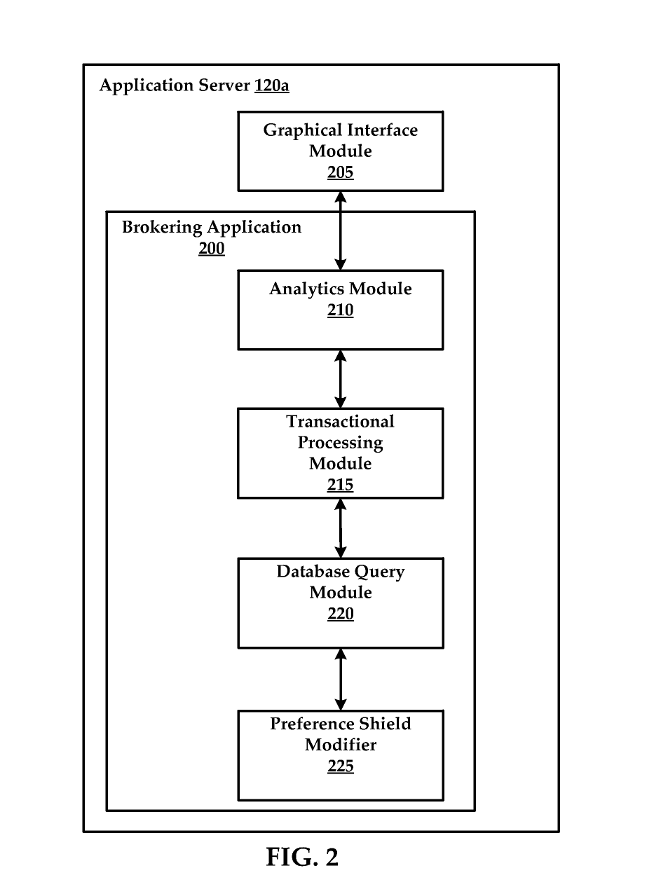

Referring now to FIG. 2, the application server 120a may include a brokering application 200. According to some embodiments, the brokering application 200 may include one or more modules or engines that are adapted to effectuate respective functionalities attributed thereto. It will be understood that the processor of the application servers 120a-n may execute one or more of the constituent modules described herein.

According to some embodiments, the brokering application 200 may include a graphical interface module 205, an analytics module 210, a transactional processing module 215, a database query module 220, and a preference shield modifier 225.

It is noteworthy that the brokering application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the brokering application 200 may include separately configured web servers (e.g., application servers 120a-n).

In some embodiments, the graphical interface module 205 may generate various graphical user interfaces that allow end users (via their computing system 105) to interact with the system 110. For example, the graphical interface module 205 may generate one or more web-based interfaces that allow end users to interact with the system 110 to broker preference shields.

By way of non-limiting example, the graphical interface module 205 may generate an online or “web-based” preference shield store where authors may sell or broker preference shield zones or entire preference shields. Portions of preference shields may be referred to as a “preference shield zone.” That is, a preference shield may be comprised of a plurality of preference shield zones. Exemplary preference shield zones may include food, lodging, and so forth.

Preference shield zones may be further subdivided. For example, food may divide into more specific subcategories such as French, Indian, and so forth. Preference shield zones may be subdivided to any level of specificity desired.

These preference shields may include preference shields that have been generated by an author, or may include preference shields that are being resold after modification by a consumer. The price for individual preference shield zones or entire preference shields may be determined by the author, or may be provided free of charge. In some embodiments, preference shields that are offered free of charge may have advertisements or other marketing offers associated with the preference shield. Therefore, revenue may be generated from sales created by displaying the marketing offers, rather than direct sales of the preference shields.

In addition to providing a marketplace for selling or offering preference shields, the analytics module 210 may provide authors with tools that allow them monitor analytics relative to the use of their preference shields. For example, the system 110 may display information such an aggregate number of consumers who looked at the preference shield, how many consumers put the preference shield in their wish list, how many individual actually purchased the preference shield, ratings, trends, and so forth.

The transactional processing module 215 may also provide the necessary backend transactional processing systems for authorizing payments, the calculation and payment of royalties to sellers, marketing of preference shields to customers, billing, dispute resolution, and many other backend transactional processing system functionalities that would be known to one or ordinary skill in the art with the present disclosure before them.

In some instances, the transactional processing module 215 may indicate that a preference shield or preference shield zone has been selected for purchase. The exchange of monetary compensation between the consumer and the author may occur outside the confines of the transactional processing module 215. Thus, authorization may refer to the selection for purchase of the preference shield or preference shield zone, the actual exchange of monetary compensation between the consumer and the author to compensate the author for the purchase of the preference shield or preference shield zone. In other instances, authorization may include the delivery of the purchased preference shield or preference shield zone after monetary compensation has been authorized (e.g., funds have been verified) or actually received by the author.

Additionally, the system 110 may allow for the sharing of preferences through the preference shield store. For example, content authors may offer preference shield zones (or entire preference shields) for sale to known connections such as friends and family. In other embodiments, the author may market their preferences to the wider public via social media platforms. For example, the author may generate a social networking message that includes a hyperlink that points interested parties back to the preference shield store, and specifically to the preference shield zones that are being offered for sale by the author.

Because preference shield data may be highly marketable and/or valuable, the transactional processing module 215 may encode or provide a preference shield with digital rights management features or other security features that prevent unfettered transfers of preference shields between consumers without authorization from the author. Advantageously, digital rights management features ensure that preference shield authors may restrict unauthorized dissemination or utilization of their preference shields without appropriate compensation.

For example, an authority having preference shield zones that are highly detailed relative to fine dining may be sought after by certain consumer. Because the preferences of the authority are highly respected, consumers may pay to utilize the expertise of the authority as embodied in their preference shield zones. Advantageously, authorities, celebrities, or other individuals having particularized or valuable preferences may sell their preference shield zones to interested consumers via the preference shield store.

Additionally, the transactional processing module 215 may store modifications to purchased preferences shields as layers to prevent consumers from improperly re-selling modified preference shields. For example, the transactional processing module 215 may prevent consumers from importing a preference zone for fine jewelry, then subsequently adding a preference relative to sapphires, and then selling it in the consumer portal, without paying a reseller fee to the original author. As stated above, changes to an existing preference zone (or preference shield) may be stored as customization layers for the deltas in order for the digital rights of the preference shield of the original author to be protected.

According to some embodiments, consumers may search for preference shield zones via the preference shield store. Searches may include keywords, topics, phrases, and so forth that may be utilized by the database query module 220 to search the databases 125a-n for preference shield zones that correspond to the search. In other embodiments, the database query module 220 may periodically compare the preferences of a first user, embodied in a preference shield, against other preference shields included in the databases 125a-n, and suggest potential preference shield zones that may be of interest to the first user.

Upon the selection of one or more preference shield zones that correspond to the received search terms, the graphical interface module 205 may arrange the selections for display via the web-based interface. Each of the preference shield zones that were selected by the database query module 220 may be provided in a visual format along with descriptive information such as author name, creation date, price, and so forth. Additional preference shield zones that may be of interest to the consumer (but that may not necessarily correspond to the search terms) may also be provided in response to the consumer selecting one of the located preference shield zones. For example, an additional preference shield by the same author may be suggested to the consumer.

In some embodiments, if multiple preference shield zones are selected, the database query module 220 may rank the selected preference shield zones based upon the number of preferences in the preference shield zone that are likely to correspond to the preferences of the consumer.

Upon the purchase or selection (if free) of one or more preference shield zones, the preference shield modifier 225 may be executed by the system 110 to combine the one or more preference shield zones with the main preference shield (if the consumer has a preference shield) of the consumer. If the preference shield modifier 225 determines that preferences included in the preference shield zones interfere or conflict with preferences that are included in the main preference shield, the preference shield modifier 225 may prompt the consumer to overwrite the older preference or ignore the new preference.

According to some embodiments, the preference shield modifier 225 may be executed to update the main preference shield of the consumer based upon changes to previously purchased preference shield zones. For example, if the author updates their preference shield zone, the preference shield modifier 225 may obtain the changes and update the main preference shield of the consumer accordingly. In some embodiments, updates to a preference shield zone may be obtained for a particular price, or may be included in the original price of the preference shield zone. If updates are sold optionally, the transactional processing module 215 may be executed to facilitate the purchase of the update and ensure that all parties to the transaction are compensated.

In some embodiments, rather than utilizing a web-based interface, the preference shield store may include a preference shield store dataset that may be accessed via a preference shield application resident on a computing system. The preference shield application may be particularly configured to display the preference shield store based upon the device. Upon launching the preference shield application on the computing system 105, the computing system 105 accesses the preference shield store dataset resident on the system 110. The application then renders views of the preference shield store on the computing system 105, typically in the form of a graphical user interface.

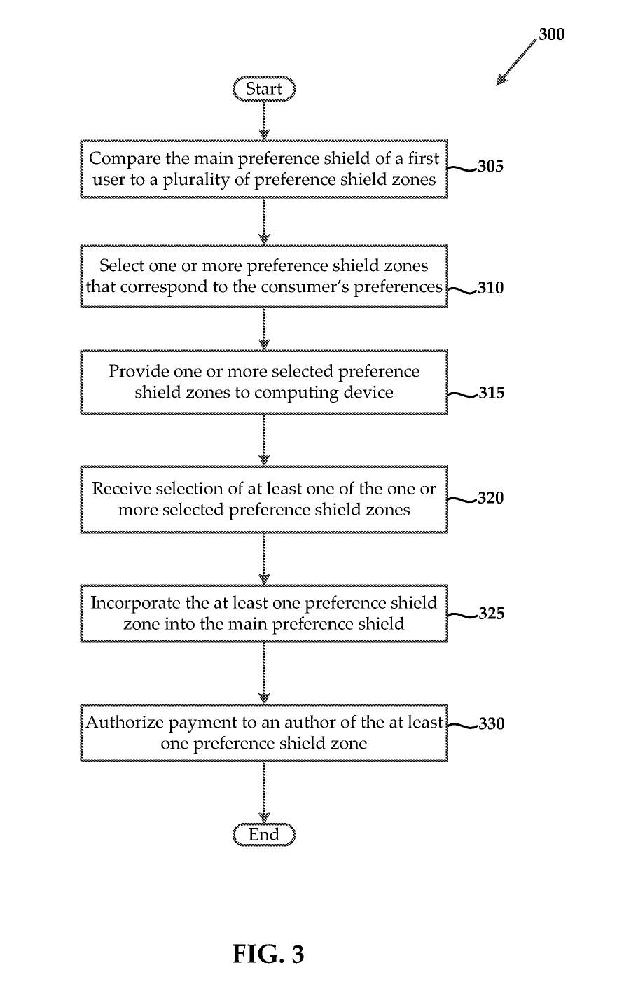

FIG. 3 illustrates and a flowchart of an exemplary method 300 for brokering the exchange of preference shield zones. In some embodiments, the method 300 may include executing instructions stored in memory by a processor. The instructions may be configured to first 305 compare the main preference shield of a first user to a plurality of preference shield zones. It will be understood that the main preference shield may include preferences corresponding to the interests of a consumer. Additionally, the preference shield zones may be included in a database that is accessible by exemplary systems of the present technology, such as system 110.

Next, the method 300 may select one or more preference shield zones that correspond to the preferences of the consumer in step 310 along with a step 315 that provides the one or more selected preference shield zones to a computing system.

In some embodiments, the method 300 may include a step 320 that receives selection of at least one of the one or more selected preference shield zones from the computing system. After selection of at least one preference shield zone, the method 300 may incorporate the at least one preference shield zone into the main preference shield of the consumer in step 325.

To ensure that authors of preference shield zones are compensated for the use of their preference shields, the method 300 may authorize payment to an author of the at least one preference shield zone in step 330. This step 330 may be understood to include the authorization of payment based upon the selection, and may not include the actual authorization of payment as typically contemplated by a third party credit processing entity (e.g., credit card company).

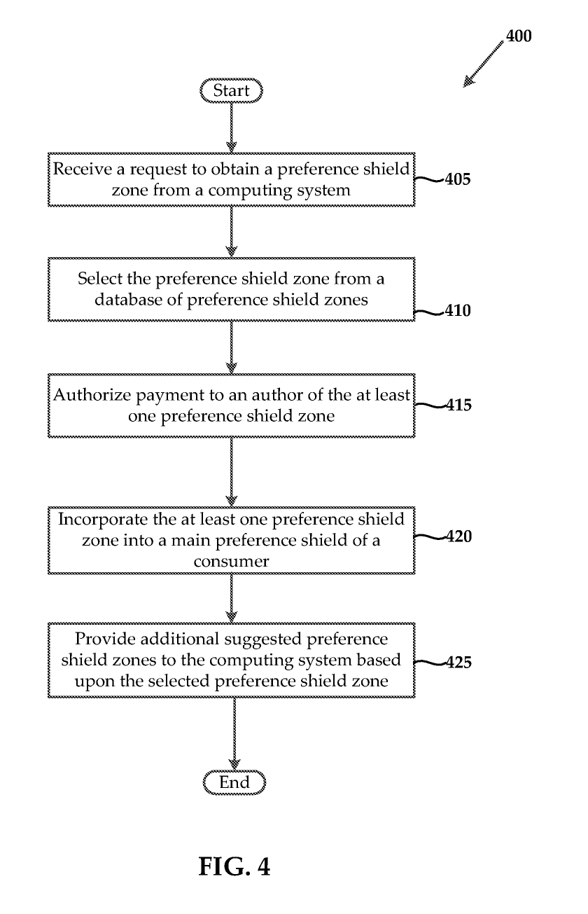

FIG. 4 illustrates another flowchart of an exemplary method 400 for brokering the exchange of preference shield zones. In some embodiments, the method 400 may include executing instructions stored in memory by a processor. The instructions may be configured to first 405 receive a request to obtain a preference shield zone from a computing system. It is noteworthy to mention that the preference shield zone may be created by an author.

Next, the instructions may be configured 410 to select the preference shield zone from a database of preference shield zones. It will be understood that the database may be accessible by exemplary systems of the present technology, such as system 110.

The instructions may then be executed to authorize payment to an author of the at least one preference shield zone in step 415, along with incorporating the preference shield zone into a main preference shield of the consumer in step 420. Lastly, the instructions may be executed in step 425 to provide additional suggested preference shield zones to the computing system based upon the selected preference shield zone.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 5 illustrates an exemplary computing system 500 that may be used to implement an embodiment of the present technology. The computing system 500 of FIG. 5 may be implemented in the contexts of the likes of computing systems, networks, servers, or combinations thereof. The computing system 500 of FIG. 5 includes one or more processors 510 and main memory 520. Main memory 520 stores, in part, instructions and data for execution by processor 510. Main memory 520 may store the executable code when in operation. The system 500 of FIG. 5 further includes a mass storage device 530, portable storage medium drive(s) 540, output devices 550, input devices 560, a display system 570, and peripheral devices 580.

The components shown in FIG. 5 are depicted as being connected via a single bus 590. The components may be connected through one or more data transport means. Processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 may store the system software for implementing embodiments of the present invention for purposes of loading that software into main memory 520.

Portable storage device 540 operates in conjunction with a portable non-volatile storage medium, such as a floppy disk, compact disk, digital video disc, or USB storage device, to input and output data and code to and from the computer system 500 of FIG. 5. The system software for implementing embodiments of the present invention may be stored on such a portable medium and input to the computing system 500 via the portable storage device 540.

Input devices 560 provide a portion of a user interface. Input devices 560 may include an alphanumeric keypad, such as a keyboard, for inputting alpha-numeric and other information, or a pointing device, such as a mouse, a trackball, stylus, or cursor direction keys. Additionally, the computing system 500 as shown in FIG. 5 includes output devices 550. Suitable output devices include speakers, printers, network interfaces, and monitors.

Display system 570 may include a liquid crystal display (LCD) or other suitable display device. Display system 570 receives textual and graphical information, and processes the information for output to the display device.

Peripherals devices 580 may include any type of computer support device to add additional functionality to the computer system. Peripheral device(s) 580 may include a modem or a router.

The components provided in the computer system 500 of FIG. 5 are those typically found in computer systems that may be suitable for use with embodiments of the present invention and are intended to represent a broad category of such computer components that are well known in the art. Thus, the computer system 500 of FIG. 5 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
executing instructions by a processor, the instructions stored in memory, to:
receive a request to obtain a preference shield zone from a computing system, the preference shield zone being created by an author;
select a preference shield zone from a database of preference shield zones that corresponds to the request;
incorporate the preference shield zone into a main preference shield of a consumer; and
authorize payment to an author of the preference shield zone.

2. The method according to claim 1, further comprising provide additional suggested preference shield zones to the computing system based upon the selected preference shield zone.

3. The method according to claim 1, further comprising periodically incorporate updates to the selected preference shield zone into the main preference shield.

4. The method according to claim 3, further comprising incorporate additional preference shield zones of the author into the preference shield of the consumer.

5. The method according to claim 1, further comprising transmit a price for the selected preference zone to the consumer.

6. The method according to claim 1, further comprising:
select a plurality of preference shield zones from a database of preference shield zones that correspond to the request;
rank the selected plurality of preference shield zones according to preferences of the consumer included in a main preference shield of the consumer; and
provide the ranked plurality of preference shield zones to the consumer.

7. The method according to claim 1, further comprising associate an advertisement with the preference shield zone, wherein the authorized payment includes revenue generated by the advertisement.

8. The method according to claim 1, wherein the preference shield zone includes digital rights management that prevents unauthorized use of the preference shield zone.

9. The method according to claim 1, further comprising:
detect a conflict between a preference included in the main preference shield and a preference included in the selected preference shield zone;
notify the consumer of the conflict; and
overwrite the preference in the main preference shield with the preference included in the selected preference shield zone if authorized by the consumer.

10. A system, comprising:
a processor; and
logic encoded in one or more tangible media for execution by the processor and when executed operable to perform operations comprising:
receiving a request to obtain a preference shield zone from a computing system, the preference shield zone being created by an author;
selecting a preference shield zone from a database of preference shield zones that corresponds to the request;
incorporating the preference shield zone into a main preference shield of a consumer; and
authorizing payment to an author of the preference shield zone.

11. The system according to claim 10, wherein the processor further executes the logic to perform an operation of providing additional suggested preference shield zones to the computing system based upon the selected preference shield zone.

12. The system according to claim 10, wherein the processor further executes the logic to perform an operation of periodically incorporating updates to the selected preference shield zone into the main preference shield.

13. The system according to claim 12, wherein the processor further executes the logic to perform an operation of incorporating additional preference shield zones of the author into the preference shield of the consumer.

14. The system according to claim 10, wherein the processor further executes the logic to perform an operation of transmitting a price for the selected preference zone to the consumer.

15. The system according to claim 10, wherein the processor further executes the logic to perform operations of:
selecting a plurality of preference shield zones from a database of preference shield zones that correspond to the request;
ranking the selected plurality of preference shield zones according to preferences of the consumer included in a main preference shield of the consumer; and
providing the ranked plurality of preference shield zones to the consumer.

16. The system according to claim 10, wherein the processor further executes the logic to perform an operation of associating an advertisement with the preference shield zone, wherein the authorized payment includes revenue generated by the advertisement.

17. The system according to claim 16, wherein the advertisement is selected based upon preferences of the consumer included in a main preference shield.

18. The system according to claim 10, wherein the processor further executes the logic to perform operations of:
detecting a conflict between a preference included in the main preference shield and a preference included in the selected preference shield zone;
notifying the consumer of the conflict; and
overwriting the preference in the main preference shield with the preference included in the selected preference shield zone if authorized by the consumer.

19. A method for brokering preference shield zones, the method comprising:
executing instructions by a processor, the instructions stored in memory, to:
compare a main preference shield of a first user to a plurality of preference shield zones, the main preference shield including preferences corresponding to interests of the first user, the preference shield zones being included in a database;
select one or more preference shield zones that correspond to the preferences of the first user;
provide the one or more selected preference shield zones to a computing system;
receive a selection of at least one of the one or more selected preference shield zones from the computing system;
incorporate the at least one preference shield zone into the main preference shield of the first user; and
authorize payment to an author of the at least one preference shield zone.
